(19) United States
(12) Patent Application Publication
(10) Pub. No.: US 2014/0168642 A1
(43) Pub. Date: Jun. 19, 2014

(54) DEVICE AND METHOD FOR DETERMINING TILT ANGLE OF CAMERA ACTUATOR MODULE

(71) Applicant: Hon Hai Precision Industry Co., Ltd., New Taipei (TW)

(72) Inventor: CHANG-WEI KUO, New Taipei (TW)

(21) Appl. No.: 13/924,631

(22) Filed: Jun. 24, 2013

(30) Foreign Application Priority Data
Dec. 13, 2012 (TW) 101147096

(51) Int. Cl. G01B 11/26

(52) U.S. Cl. CPC G01B 11/26
USPC 356/138

(57) ABSTRACT

A method for determining a tilt angle of a camera actuator module is disclosed. A test device is placed on a precision tilt angle fine-tuning seat. The precision tilt angle fine-tuning seat is adjusted to horizontally orient the test device. The camera actuator module is placed on the test device when the test device is horizontally oriented. A coated and thin glass sheet is placed on the camera actuator module. A pressing plate is placed on the camera actuator module and pressed downward to cause the camera actuator module to be steadily position in contact with the test device. A laser beam is emitted onto the glass sheet and the tilt angle of the camera actuator module is determined using a laser rangefinder.

### BACKGROUND

1. Technical Field

The present disclosure relates to cameras, and particularly to a device and a method for determining a tilt angle of a camera actuator module.

2. Description of Related Art

When a support of a camera actuator module is tilted, the optical axis of the camera lens may tilt. When the optical axis of the camera lens is tilted, a camera having the camera actuator module cannot take optimal images. Therefore, it is necessary to measure the tilt angle of the actuator module to determine whether the support is tilted.

### BRIEF DESCRIPTION OF THE DRAWINGS

Many aspects of the present disclosure will be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is an assembled view of a device for determining a tilt angle of a camera actuator module, in accordance with an exemplary embodiment.

FIG. 2 is an exploded, perspective view of the device of FIG. 1.

FIG. 3 is a flowchart of a method for determining the tilt angle of the camera actuator module, in accordance with an exemplary embodiment.

### DETAILED DESCRIPTION

Embodiments of the present disclosure will be described with reference to the accompanying drawings.

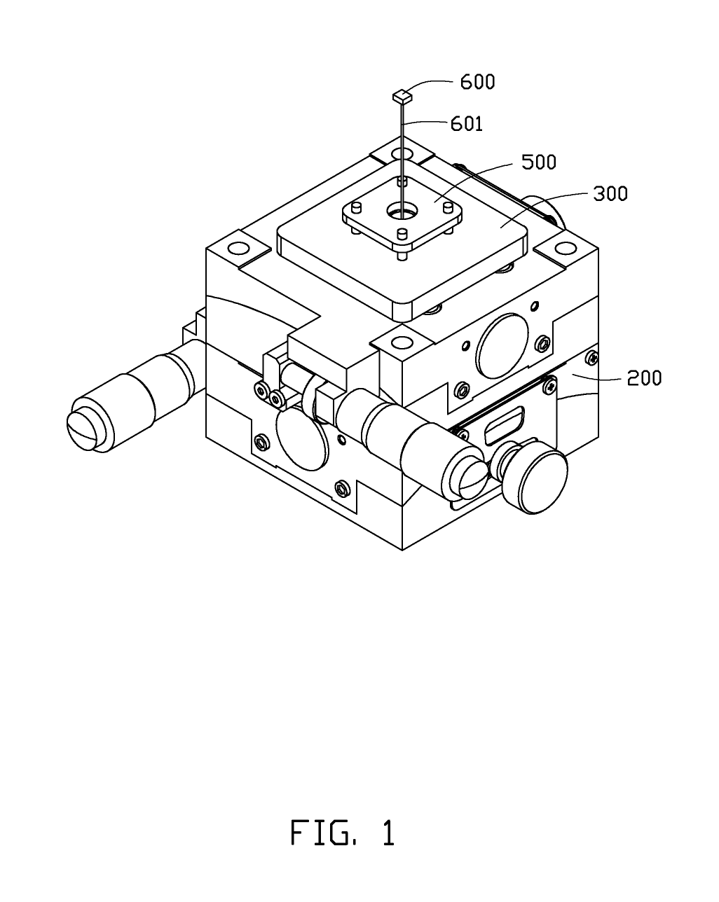

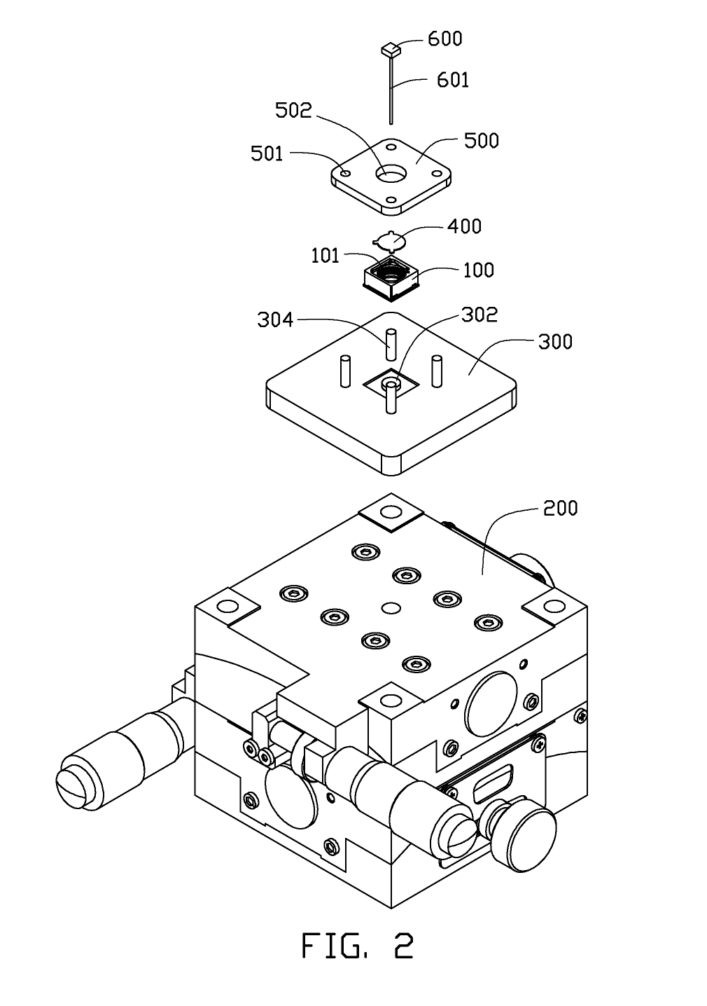

Referring to FIGS. 1-2, an embodiment of a device for determining a tilt angle of a camera actuator module 100 includes a precision tilt angle fine-tuning seat 200, a test device 300, a coated and thin glass sheet 400, a pressing plate 500, and a laser rangefinder 600.

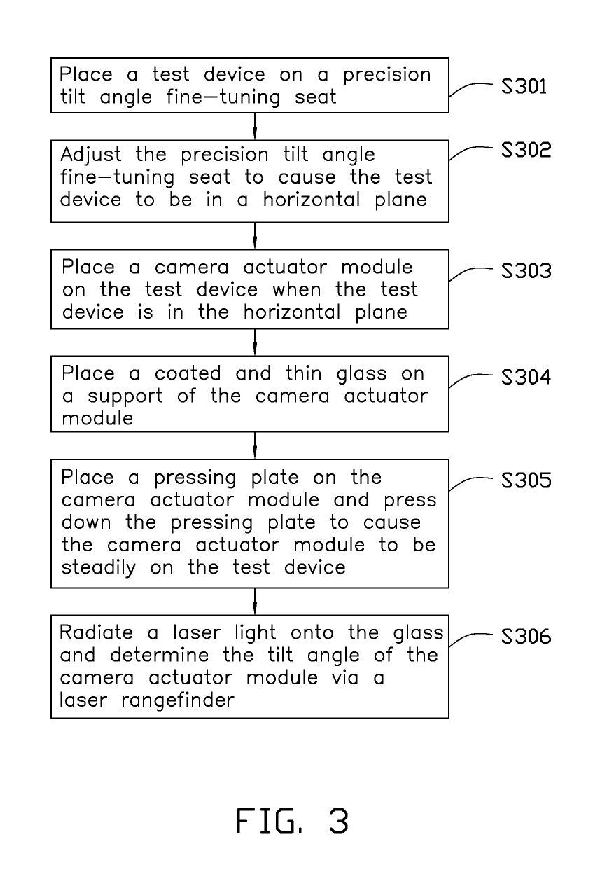

FIG. 3 is a flowchart of a method for determining a tilt angle of the camera actuator module 100, in accordance with an exemplary embodiment.

In step S301, the test device 300 is placed on the seat 200. The test device 300 includes a reflector sheet 302 arranged on a surface of the test device 300, and a number of posts 304 protruding from the same surface of the test device 300 and surrounding the reflector sheet 302.

In step S302, the seat 200 is adjusted to orient the test device 300 horizontally. In this embodiment, the laser rangefinder 600 emits a laser beam onto the reflector sheet 302 to determine a tilt angle of the test device 300. If the test device 300 is determined not to be horizontally oriented according to the tilt angle of the test device 300, the seat 200 is further adjusted. The seat 200 can be any known fine-tuning seat which can be operated to adjust the position of the test device 300, and will not be described in detail.

In step S303, the camera actuator module 100 is placed on the test device 300. In this embodiment, the camera actuator module 100 is placed within a space formed by the posts 304 of the test device 300.

In step S304, the glass sheet 400 is placed on a support 101 of the camera actuator module 100. The support 101 is for supporting a camera lens.

In step S305, the pressing plate 500 is placed on the camera actuator module 100 and is pressed downward to cause the camera actuator module 100 to be steadily positioned in contact with the test device 300. In this embodiment, the pressing plate 500 defines a number of first through holes 501 each corresponding to a post 304 and a second through hole 502 surrounded by the first through holes 501. The second through hole 502 allows the glass 400 to be exposed.

In step S306, the laser rangefinder 600 emits a laser beam 601 onto the glass sheet 400 to determine the tilt angle of the camera actuator module 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A method for determining a tilt angle of a camera actuator module, comprising:
placing a test device on a precision tilt angle fine-tuning seat;
horizontally orienting the test device by adjusting the precision tilt angle fine-tuning seat;
placing the camera actuator module on the horizontally oriented test device;
placing a coated and thin glass sheet on the camera actuator module;
placing a pressing plate on the camera actuator module and pressing the pressing plate downward to cause the camera actuator module to be steadily positioned in contact with the test device; and
emitting a laser beam onto the glass sheet and determining the tilt angle of the camera actuator module using a laser rangefinder.

2. The method as described in claim 1, wherein horizontally orienting the test device by adjusting the precision tilt angle fine-tuning seat comprising:
emitting a laser beam onto a reflector sheet of the test device and determining a tilt angle of the test device using the laser rangefinder; and
adjusting the precision tilt angle fine-turning seat to orient the test device horizontally according to the tilt angle of the test device.

3. A device for determining a tilt angle of a cameral actuator module, comprising:
a precision tilt angle fine-tuning seat;
a test device arranged on the precision tilt angle fine-tuning seat, the precision tilt angle fine-tuning seat configured to orient the test device horizontally, the test device configured for placing a camera actuator module thereon;
a coated and thin glass sheet for being arranged on the camera actuator module;
a pressing plate configured for pressing the camera actuator module toward the test device to cause the camera actuator module to be steadily positioned in contact with the test device; and
a laser rangefinder configured to emit a laser beam onto the glass sheet to determine the tilt angle of the camera actuator module.

4. The device as described in claim 3, wherein the test device comprises a reflect sheet, the laser rangefinder is configured to emit a laser beam onto a reflector sheet of the test device to determine the tilt angle of the test device.
